(19) United States
(12) Patent Application Publication
(10) Pub. No.: US 2023/0000099 A1
(43) Pub. Date: Jan. 5, 2023

(54) PROCESS FOR PASTEURISING CHEESE

(71) Applicant: Food Mechanique Australia Pty Limited, Donvale, Victoria (AU)

(72) Inventor: Stanley KILROY, Donvale, Victoria (AU)

(73) Assignee: Food Mechanique Australia Pty Limited, Donvale, Victoria (AU)

(21) Appl. No.: 17/782,097

(22) PCT Filed: Dec. 17, 2020
(86) PCT No.: PCT/AU2020/051386

§ 371 Date: Jun. 2, 2022

(30) Foreign Application Priority Data
Dec. 18, 2019 (AU) 2019904798

(51) Int. Cl. A23C 19/097; A23C 19/072; A23C 19/093

(52) U.S. Cl. CPC A23C 19/0973; A23C 19/072; A23C 19/093; A23C 2250/054

(57) ABSTRACT

This invention relates to methods of pasteurising cheese in the presence of a hydrated hydrocolloid to produce a pasteurised cheese emulsion in a substantially homogeneous form with negligible amounts of additives. Cheese products prepared from such emulsified cheese are also disclosed. Use of the resulting pasteurised cheese emulsion as an emulsifying agent is also described.

This application claims priority to Australian Provisional Application No. 2019904798 entitled “Process for Pasteurising Cheese” filed 18 Dec. 2019, the contents of which are incorporated herein by reference in their entirety.

### FIELD OF THE INVENTION

This invention relates to pasteurisation of cheese, and in particular to methods of pasteurising cheese in the presence of a hydrated hydrocolloid to produce a pasteurised cheese emulsion with no, or negligible amounts of additives. Use of the resulting pasteurised cheese emulsion as an emulsifying agent is also described. Cheese products prepared from such emulsified cheese are also disclosed.

### BACKGROUND OF THE INVENTION

Methods of processing cheese and processed cheese products obtained from such processes are well known and date back to the early 20^{th} century when James Kraft, working with the technologists of the Chicago-based Phenix Cheese Company, introduced phosphates to facilitate the processing of Cheddar cheese. Processing cheese to about 85° C. was discovered to extend the keeping qualities of the cheese, eliminating or reducing the occurrence of early spoilage due to drying or growth of yeasts or moulds. The liquid emulsion (sol) resulting from such hot processing provided easy access to fixed weight products and a variety of packaging options. Processed cheese products thus provide advantages such as convenience of packaging and extended shelf life.

Commercial processing of cheese generally involves pre-blending selected emulsifiers with cheese combined with water and a selection of additional ingredients selected according to the circumstances. For small scale production, typically the blended cheese mass is heated in a jacketed batch processor fitted with efficient mixing and a mechanical shearing mechanism. Heat is applied indirectly via a jacket; or by steam injection directly into the cheese mass. High-volume commercial production has evolved into a highly efficient continuous processing system employing direct steam injection. However, the ingredients are usually still prepared as batches in large mixing and blending machinery.

Typically, the temperature is raised to above 85 or 95° C. during processing to effect pasteurisation and achieve the desired texture. However, if required, the cheese emulsion may undergo sterilisation by heating to about 140° C. When the liquid cheese sol reaches the desired temperature it is usually discharged and pumped to packaging machinery.

Processed cheese generally described as a stable oil-in-water emulsion. Emulsifying salts, also known as melting salts, are usually added during cheese pasteurisation to stabilize the cheese emulsion and prevent separation, or syneresis, of the cheese components caused by heating. Emulsifiers can be used to regulate the pH of the cheese, its rheology, moisture content, melting characteristics, and the like. The stability of the processed cheese is determined by the processing time and temperature, together with the emulsifiers used.

The use of emulsifying salts during pasteurisation improves the emulsification properties of caseins by displacing the calcium phosphate complexes in the insoluble calcium-paracaseinate phosphate network present in natural cheese. This disrupts the cross-links of the various monomers of casein in the network. The disruption of the calcium phosphate complex in conjunction with heating and mixing leads to hydration and partial dispersion of the calcium-paracaseinate phosphate network together with interaction with fat via hydrophobic interactions. After cooling, the partially dispersed caseinate matrix forms a gel network giving essentially a fat phase evenly dispersed in a partially dispersed casein gel network.

Cheese processors have a large range of emulsifiers at their disposal. Typical emulsifying salts include sodium or potassium salts of polyvalent anions, such as phosphate, hexametaphosphate, pyrophosphate, citrate and tartrate. These salts help disrupt the calcium phosphate-linked protein network present in natural cheese and also adjust the pH. This causes hydration of the caseins present in natural cheese facilitating their interaction with the water and fat phases, thereby producing a homogeneous pasteurised cheese emulsion. The amount and type of emulsifying salt will vary in accordance with the requirements of the type of processed cheese product, however emulsifying salts are typically present in amounts totaling about 1-5% w/w.

The presence of these emulsifying salts may be considered to render the processed cheese less desirable from a health perspective due to the increased sodium or potassium content. Emulsifying salts may also impart a discernible taste and may adversely affect the flavour of the cheese product.

Pasteurised cheese has evolved over time to include products comprising ingredients such as lactose, starches, butter, skim milk powder, whey, buttermilk, vegetable fats or oils, preservatives, stabilizers or emulsifying agents, such as emulsifying salts, in addition to cheese and water. These additional ingredients are often included to improve stability or the handling properties of the cheese mass to facilitate economic commercial production of cheese products.

It may be necessary to incorporate certain additives to modify texture, viscosity or rheology of the cheese emulsion to facilitate ease of processing or prevent the melting cheese from forming an intractable mass in the processing equipment. This problem is typical during pasteurisation of certain cheese varieties, and can lead to processing problems such as placing strain on processing equipment by fouling stirrers or blocking pipework. These additional ingredients can detract from the perceived purity of the product, and can affect the natural cheese flavour and the characteristics of the parent cheese.

Moreover, additives such as lactose are known to encourage mould growth, making it necessary to add preservatives such as salt or ascorbic acid to the cheese product. The relatively high level of sodium in the emulsifying salts used during emulsification, together with the sodium already present in the cheese from salt (sodium chloride) used during its manufacture has exacerbated the decline in the popularity of processed cheeses due to a perceived link between salt intake and an increase in heart disease and obesity. This has resulted in a decline in consumption of processed cheese in most countries.

There is presently a worldwide demand for foods with a significantly reduced sodium content. This forms part of a general movement towards a preference for higher quality, healthier, better tasting or higher purity food. Thus, there is a demand for food products that comprise natural ingredients and are low in additives. There is a need for pasteurised cheese products that retain the keeping qualities and convenience of processed cheese, but retain a high cheese content and degree of purity. There is also a desire for pasteurised cheese that preserves the characteristics of the originating cheese, such as varietal flavour or texture.

During pasteurisation of cheese using conventional commercial methods, the viscosity of the melting cheese generally decreases with an increase in temperature, making it capable of being readily pumped at the processing temperature. The processing temperature is generally about 95° C. At this temperature, the hot cheese sol is stable and is usually packaged at this stage. However, if it is retained in the hot processing environment, generally in the hands of an experienced operator, for a further short dwell-time the product will spontaneously increase in viscosity. This process is known in the art as “creaming”. Creaming results not only by an increase in viscosity, but also by the appearance of a finer texture. From observation, this appears to result from the effect of heat and agitation on the structure of the casein micelles causing division of the micelles into smaller particles and thus providing additional surface area for moisture uptake.

The creaming process is particularly significant as it determines the properties of not only the melted pasteurised cheese emulsion, but also those of the final product. Creaming results in a viscous mixture with a desirable fine texture. However, the creaming step is a critical phase of cheese processing. The creamed batch can suddenly and spontaneously thicken and become an unworkable mass resulting in the need for immediate termination of the process. This is known as “over creaming”, an occurrence resulting in a solid mass of intractable matter incapable of being poured or pumped. It is believed that the observed over creaming phenomenon may be an extension of the internal processes resulting in creaming of the cheese sol. Thus, over creaming is believed to be due to increased, or total, disruption of the structure of the casein micelles thus presenting increased surface area for absorption of moisture. The occurrence of over creaming is very destructive as the product has no further use. Over creamed product has been observed to act as an efficient emulsifier in subsequent batches of cheese processing, but it has uncontrollable and unpredictable casein emulsifying properties and will adversely affect an entire batch of processed cheese by its addition.

The majority of contemporary high throughput processing and packaging equipment for preparing cheese products rely on the bulk cheese mass to remain substantially fluid for sufficient periods of time to facilitate procedures such as pumping or pouring. In addition to a need for developing a cheese product free of artificial additives that retains varietal flavour of its parent cheese, it is desirable that the cheese product has enhanced handling properties in the molten form during production. There is also a need for cheese products that resist spoilage and have good shelf stability.

Methods of liquefying cheese in the absence of emulsifying salts or other emulsifying agents have been reported (WO 2008/122094), however the processes disclosed therein have the potential drawback in that they rely on the use of a carefully controlled heating regime in combination with controlled incorporation of water to prevent separation of the protein, fat and water components of the cheese through the process of syneresis. These methods have the potential restriction of being most effective for use with well matured Cheddar cheese and also require an extended time for the process to be effective.

Accordingly, there is a need for improved or alternative methods for producing pasteurised cheese products that address one or more of the problems of present cheese products and methods of producing them.

### SUMMARY OF THE INVENTION

The present invention is predicated, at least in part, on the discovery that cheese can be pasteurised in the presence of water and a hydrated hydrocolloid to form an emulsion of the desired viscosity and solids content, without occurrence of syneresis, and in the absence of additional emulsifying salts. The resulting pasteurised cheese has good shelf life and comprises almost exclusively cheese and water, with only a very small or negligible amount of a naturally occurring hydrocolloid as the processing agent. In preferred embodiments, the hydrocolloid is hydrated and gelled prior to addition to the cheese and water mixture.

A further discovery is that pasteurised cheese prepared using hydrated hydrocolloid is itself a useful emulsification agent. As such, the inventor has observed that this pasteurised cheese has useful properties and finds application as an emulsifying rework for subsequent batches of cheese processing. In some forms, the pasteurised cheese provides an emulsifying rework with predictable and consistent emulsifying properties. These properties are advantageous when compared to “over-creamed” processed cheese which, although it possesses powerful emulsifying properties, its uncontrollable nature makes it impractical to use in a commercial setting.

The pasteurised cheese prepared in accordance with the methods described herein comprises almost exclusively cheese and water, with only a small or negligible amount of hydrocolloid. In preferred embodiments, there is substantially no residual hydrocolloid present. When the pasteurised cheese is used as rework, the small level of hydrocolloid present in the pasteurised cheese can be effectively eliminated totally by progressive dilution in subsequent batches of cheese pasteurisation, or as part of a continuous process. Thus, a high purity pasteurised cheese product is obtained.

In accordance with the invention, cheese is pasteurised by heating in the presence of water and a small amount of hydrated hydrocolloid. The resulting pasteurised cheese mass is a hot, stable emulsion with good handling properties. This hot cheese emulsion is capable of being pumped or poured, and thus is compatible with food processing equipment conventionally used in the preparation of pasteurised cheese products. Furthermore, there is no requirement for additional ingredients, accordingly pasteurised cheese products wherein cheese, water and hydrocolloid make up at least 95% w/w, and preferably at least 99%, 99.5% or 99.9% of the cheese product by weight, may be prepared. Furthermore, the inventor has discovered that pasteurised cheese comprising a negligible amount of hydrocolloid may be prepared, thus the pasteurised cheese product substantially consists of only cheese and water. For example cheese and water make up at least 95% w/w, and preferably at least 99%, 99.5% or 99.9% of the cheese product by weight, may be prepared.

The pasteurised cheese mass may be subjected to further processing steps to enable its conversion to the desired pasteurised cheese product. For example, it may be subjected to further processing steps including heating to a higher temperature to effect sterilization. The viscosity can be increased by the injection of raw cheese of the same or different variety directly into the hot mass over a period of time that does not allow the temperature of the sol to fall below about 75° C. to about 80° C.

The resulting pasteurised cheese product comprises cheese and water, with the amount of hydrocolloid present comprising less than 0.1% w/w of pasteurised cheese product, or less. The pasteurised cheese product is substantially free of any other additives. The cheese product has excellent keeping qualities and long shelf life. The very small amount of hydrocolloid present does not adversely affect the texture or flavour of the pasteurised cheese emulsion. The resulting pasteurised cheese products have no added emulsifying salts, and therefore have a lower salt content than conventionally processed cheese. Furthermore, the products are of high purity with respect to the originating cheese, and substantially retain its characteristic flavour. Thus, in several aspects, the present invention provides methods of pasteurising cheese, and products of these methods.

Accordingly, there is provided a method for pasteurising cheese comprising raising the temperature of the cheese to at least 85° C. in the presence of water and a sufficient amount of a hydrated hydrocolloid such that the water is incorporated into the cheese without syneresis to provide pasteurised cheese in a substantially homogeneous form; the cheese, water and hydrocolloid together forming at least 95% w/w, preferably at least 99.5% w/w of the pasteurised cheese thus formed.

It will be appreciated that the hydrated hydrocolloid may be sufficiently dilute, or may comprise sufficient unbound water, to facilitate the preparation of pasteurised cheese as an emulsion of the required consistency. Thus, depending on the circumstances, additional water may not be necessary. Accordingly, the methods of the invention may comprise heating cheese to at least 85° C. in the presence of a sufficient amount of a hydrated hydrocolloid such that water is incorporated into the cheese without syneresis to provide pasteurised cheese in a substantially homogeneous form; the cheese, water and hydrocolloid together forming at least 95% w/w of the pasteurised cheese thus formed.

The resulting pasteurised cheese mass may be allowed to cool to provide a pasteurised cheese product, for example, a spreadable gel or paste; or a shaped cheese product such as cheese slices. Thus, in another aspect, there is provided a method for pasteurising cheese to form a pasteurised cheese product said method comprising the steps of:
a) raising the temperature of the cheese to at least 85° C. in the presence of water and a sufficient amount of a hydrated hydrocolloid such that the water is incorporated into the cheese without syneresis to provide pasteurised cheese in a substantially homogeneous form; and
b) performing one or more additional processing steps to form a pasteurised cheese product wherein the cheese, water and hydrocolloid form at least 95% w/w, preferably at least 99.5% w/w, of the cheese product thus formed.

It has also been discovered that additional cheese can be incorporated into the hot emulsified cheese liquid without destabilizing or otherwise adversely affecting the emulsion. This provides access to pasteurised cheese with a high solids content which, on cooling, affords a pasteurised cheese product that may be provided in block form, or may be sliced or otherwise cut into portions.

Accordingly, in another aspect, there is provided a method for preparing a pasteurised, substantially solid cheese product, said method comprising the steps of:
a) raising the temperature of the cheese to at least 85° C. in the presence of water and a sufficient amount of a hydrated hydrocolloid such that the water is incorporated into the cheese without syneresis to provide pasteurised cheese in a substantially homogeneous form; and
b) adding a further aliquot of cheese, which may be the same or different to the cheese in step a), to the cheese mass thus formed; and/or
c) subjecting the cheese mass to conditions of such temperature, humidity or pressure so as to remove a portion of the water from the cheese; and
d) cooling the pasteurised cheese to less than 30° C.;
wherein the cheese, water and hydrocolloid form at least 95% w/w, preferably at least 99.5% w/w, of the substantially solid cheese product thus formed.

The inventor has also surprisingly discovered that the pasteurised cheese produced by the methods of the invention can itself act as an emulsifying agent for subsequent batches of cheese pasteurisation. Hence, a portion of the pasteurised cheese may be incorporated into a subsequent cheese pasteurisation batch to effect emulsification of the cheese without the requirement to add additional hydrated hydrocolloid or other emulsifying agent. It will be appreciated that this procedure dilutes the amount of hydrocolloid present and thus reduces the amount of hydrocolloid present in the subsequent batch of pasteurised cheese to considerably less than that of the parent batch.

Accordingly, there is also provided a method for pasteurising cheese comprising the steps of:
a) raising the temperature of the cheese to at least 85° C. in the presence of water and a sufficient amount of a hydrated hydrocolloid such that the water is incorporated into the cheese without syneresis to provide pasteurised cheese in a substantially homogeneous form wherein the cheese, water and hydrocolloid form at least 95% w/w, preferably at least 99% w/w, of the substantially solid cheese product thus formed; and
b) reserving a portion of the pasteurised cheese of step a); and
c) raising the temperature of a further portion of a cheese, which may be the same or different to the cheese in step a), to at least 85° C. in the presence of water and the portion of the pasteurised cheese of step b) such that the water is incorporated into the cheese without syneresis to provide pasteurised cheese in a substantially homogeneous form wherein the cheese, water and hydrocolloid form at least 95% w/w of the substantially solid cheese product thus formed; and the amount of hydrocolloid present is less than in step a).

The present inventor has discovered that an emulsification agent prepared by combining hydrated hydrocolloid, for example hydrated gelatine, with young Cheddar provides advantages when used in the pasteurisation of cheese. Accordingly, in another aspect, the present invention provides a process for preparing an emulsifying or stabilising agent comprising the steps of:
hydrating a hydrocolloid with water; and
combining the resulting hydrated hydrocolloid with young Cheddar, and optionally water, to produce a substantially homogeneous emulsifying agent.

It has also been discovered that an emulsification or stabilizing agent comprising, consisting or consisting essentially of young Cheddar and water may be prepared by combining hydrated hydrocolloid, for example hydrated gelatine, with young Cheddar. Accordingly, in another aspect, the present invention provides a process for preparing an emulsifying agent comprising the steps of:

a) hydrating a hydrocolloid with water;

b) combining the resulting hydrated hydrocolloid with young Cheddar, and optionally water, and raising the temperature to at least 85° C. to produce a substantially homogeneous emulsifying agent wherein the amount of hydrocolloid present is less than 5% w/w, preferably less than 1% w/w or 0.5% w/w;

c) reserving a portion of the mixture of step (b);

d) combining the portion of step (c) with young Cheddar, and optionally water, and raising the temperature to at least 85° C. to produce a substantially homogeneous emulsifying agent wherein the amount of hydrocolloid present is less than that in step (b); and optionally;

e) reserving a portion of the mixture of step (d); and

f) combining the portion of step (e) with young Cheddar, and optionally water, and raising the temperature to at least 85° C. to produce a substantially homogeneous emulsifying agent wherein the amount of hydrocolloid present is less than that in step (d).

In some embodiments, hydrated hydrocolloid comprises hydrocolloid and water in a ratio of from about 1:100 to about 3:100 by weight. In some embodiments, the hydrocolloid is gelatine.

### DESCRIPTION OF THE DRAWING

FIG. 1 is a schematic diagram illustrating an example of a continuous process for pasteurising cheese in accordance with an aspect of the present invention.

### DETAILED DESCRIPTION OF THE INVENTION

### Definitions

Unless defined otherwise, all technical and scientific terms used herein have the same meaning as commonly understood by those of ordinary skill in the art to which the invention belongs

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e. to at least one) of the grammatical object of the article. By way of example, “an element” means one element or more than one element.

When used herein, the term “cheese” refers to cheese made from milk, for example from a cow, sheep, goat or buffalo, especially milk from a cow. Cheese typically comprises fat, protein and water in various proportions according to the variety of the cheese and the milk source. Typically cheese also comprises salts, such as sodium chloride, added during the preparation of cheese. Methods of making cheese are well known in the art, and many varieties of cheese are known. Suitable cheese for use in the processes of the present invention are cheeses of the acid or rennet varieties, especially rennet varieties. Preferably, cheese varieties suitable for use in the methods of the present invention are Cheddar; cottage; cream; Swiss cheese, such as Emmentaler or Gruyere; Gouda; Jarlsberg; or Colby.

In some circumstances, commercial cheese manufacturers may incorporate milk protein concentrate (MPC, also known as milk protein isolate) during the production of cheese. MPC is a substance derived from milk, usually by ultrafiltration of skim milk), which contains greater than 40% by weight milk protein comprising casein and lactalbumin. In some preferred embodiments of the present invention, the cheese does not contain added MPC.

When used herein, the term “varietal cheese” refers to a cheese variety, other than Cheddar, for example, Gruyere, Emmental, Colby, or Gouda.

When used herein, the term “Cheddar” refers to a cheese variety prepared by a cheddaring process which involves milling and salting the curd followed by allowing the milled chips to pile randomly in such a manner as to impart a crumbly texture to the cheese. Young Cheddar when referred to herein is a cheese prepared by a cheddaring process that has been aged for about 2-4 months, or 2-3 months, for example about 3 months or 13-14 weeks. Cheeses typically prepared by a cheddaring process include the cheese variety known as Cheddar. Other Cheddar-type cheeses prepared using a Cheddaring process include, but are not limited to, varieties known as Gloucester, Derby, Cheshire and Leicester.

When used herein, the term “syneresis” refers to the process whereby less viscous components of the cheese mass drain from the more viscous components. Typically, syneresis refers to the separation within a cheese mass of a substantial proportion of the water and/or fat from the protein components, for example casein. Syneresis may result in pooling of water or fats.

It will be appreciated that the cheese/water/hydrocolloid mixture produced by the processes described herein will be in the form of an emulsion. When used herein, the term “emulsification” refers to the conversion of “substantially solid” cheese into a “substantially liquid” emulsion comprising cheese and generally involving incorporation of water. “Substantially solid” cheese will be understood to exhibit the properties of a solid on a macroscopic level. Cheese comprises water, fat and protein (mainly casein). It will be understood that these different components will have different melting points and heat capacities. It will be appreciated that, at room temperature, certain fats present in a cheese mass may be substantially more liquid in character than the protein therein. Nonetheless, the term “substantially solid” is understood to encompass such composite materials wherein certain components may be considered in isolation to be liquid but, as a whole, the composite material displays the properties of a solid. Likewise, a “substantially liquid” material exhibits the properties of a liquid on a macroscopic level. On a macroscopic level, a liquid readily flows. The term “substantially liquid” may be construed to encompass those composite materials wherein certain components may be considered in isolation to be solid or gaseous but, as a whole, the composite material displays the properties of a liquid. It is understood that the viscosity of a material typically varies as a function of temperature, materials typically becoming less viscous as their temperature increases. It is also known that a change in density of a material often makes a significant contribution to the decrease in viscosity observed in the material as it is heated. As used herein, an example of an “emulsification” process is a macroscopic phase transition of a substantially solid cheese to a substantially liquid cheese emulsion, observable through a decrease in viscosity under conditions of constant volume or constant pressure.

As used herein, the term “homogenous” refers to a property of a material, for example emulsified cheese, wherein the components therein, such a cheese and water, are uniformly distributed throughout to form a uniform emulsion.

When used herein, unless otherwise indicated, the term “hydrocolloid” refers to a, generally hydrophilic, substance that yields a gel with water. The hydrocolloid may comprise proteinaceous or polysaccharide components. Examples of proteinaceous hydrocolloid substances include gelatine. Polysaccharide hydrocolloids typically used in food manufacture include alginic acids/alginate, agar, arabinoxylan, carrageenans, carboxymethylcellulose, cellulose, curdlan, gellan, β-glucan and polysaccharide gums such as guar gum, gum arabic, locust bean gum and xanthan gum. In the methods described herein, the hydrocolloid is hydrated with water prior to combining with the cheese.

Hydration may be effected by dispersing the hydrocolloid in water, preferably purified or food grade water. The water may be cold, or it may be at ambient temperature. In some preferred embodiments, the water is hot, for example substantially boiling. In some embodiments, the water is at 50-100° C., for example 60-100° C., 75-95° C., 75-100° C., 80-95° C. or 90-100° C. In some embodiments, the hydrocolloid is added to water at ambient temperature and the mixture is heated, for example with stirring, to the desired final temperature to effect hydration of the hydrocolloid. In some examples, the hydrocolloid is hydrated by adding to hot water, for example water at about 90-100° C. Preferably the hydrocolloid and water mixture is subjected to vigorous stirring to avoid agglomeration.

When used herein the term “hydrated”, “hydration”, and the like refers to the binding or holding of an amount of water by a hydrocolloid. In some circumstances, it will be appreciated that the hydrated hydrocolloid may form a gel. In some embodiments the formation of a gel is preferred. In some embodiments, for example in the case of hydrated gelatine, a gel may be formed by allowing the hydrated gelatine to stand at about 5° C. A gel has an advantage of ease of handling and may be dispensed using various techniques, such as pumping. A hydrated hydrocolloid or hydrocolloid gel may be diluted with water prior to combining with cheese.

The ratio of hydrocolloid to water in a hydrated hydrocolloid can vary enormously and the actual amounts and ratios will depend on the nature of the hydrocolloid and the circumstances such as scale, nature of processing equipment, ratio of water to cheese, required consistency of pasteurised cheese product, etc. In some examples of the processes described herein, the hydrated hydrocolloid is added to a cheese and water mixture. However it will be appreciated that, in some examples, the hydrated hydrocolloid may be first added to water and then subsequently combined with the cheese. In some circumstances, it may be desirable to hydrate the hydrocolloid in the entire amount of water required for a particular process to form the hydrated hydrocolloid and subsequently combine this with the cheese. It will be appreciated that all variations of combining the cheese, hydrated hydrocolloid and water are encompassed herein.

In some examples, the ratio of hydrocolloid to water in hydrated hydrocolloid is from about 1:5 or 1:10 to about 1:500, for example 1:20 to 1:250; 1:30 to 1:300; 1:30 to 1:150; 1:30 to 1:100; 1:40 to 1:200; 1:50 to 1:200; 1:75 to 1:150, or about 1:100 by weight. In some preferred embodiments, the ratio of hydrocolloid to water in hydrated hydrocolloid is from about 1:100 to about 3:100 by weight. In some examples, the hydrated hydrocolloid comprises about 0.5% to about 5% hydrocolloid by weight, for example about 0.5% w/w to about 2.5 or 3% w/w; about 0.75% w/w to about 2% w/w, or about 0.75% w/w to about 1.5% w/w. In some examples, the ratio of hydrocolloid to water in the hydrated hydrocolloid is 1:99 or 1:100 by weight, or about 1% w/w hydrocolloid in water. In some circumstances, it may be desirable to allow the hydrated hydrocolloid to cool prior to use. In some examples, the hydrated hydrocolloid may form a gel on cooling.

In some embodiments, the hydrocolloid may be allowed to hydrate in a larger amount of water, for example about 1:200 to about 1:1000 hydrocolloid to water, for example about 1:200 to 1:700; 1:250 to 1:600; 1:400 to 1:600 or about 1:500 hydrocolloid to water by weight.

In some embodiments, the hydrated hydrocolloid is added to the cheese/water mixture. In some embodiments, the hydrated hydrocolloid and cheese/water mixture are each at ambient temperature prior to mixing, for example 15-25° C. In some preferred embodiments, the hydrated hydrocolloid is cold, for example 2-12° C., 4-10° C., or about 5° C., when added to the cheese/water mixture. However, in some circumstances, it may be desirable to add the hydrated hydrocolloid when the cheese/water mixture is at a raised temperature, for example, up to 65° C., 85° C. or 95° C.; for example 25-35° C., 30-45° C., 35-50° C., 40-55° C., 40-60° C., 45-65° C., 50-95° C.; 50-85° C. or 70-95° C. In some embodiments, the hydrated hydrocolloid may be added to the cheese/water mixture after syneresis has commenced.

When used herein, the term “gelatine”, also known as gelatin, refers to a substantially tasteless proteinaceous hydrocolloid derived from partially hydrolysed collagen. It will be appreciated that the properties and composition of gelatine will vary depending on the source(s) of collagen and the processing conditions used in its production. Conventionally, gelatine obtained using acid hydrolysis is referred to as type A gelatine; and that produced by alkaline hydrolysis of collagen is referred to as type-B gelatine. Gelatine may also be produced by enzyme catalysed hydrolysis. Both type-A and type-B gelatines are suitable for use in processing cheese in accordance with the processed described herein. However, in some embodiments of the present methods, gelatine of type-B derived from bovine sources is preferred. The physical characteristics of gelatine are characterised by its Bloom strength value (Schreiber, R. et al., Gelatine Handbook: Theory and Industrial Practice, Wiley). The amount of gelatine required in the methods described herein will depend on factors such as the ratio of water to cheese, and the strength of the gelatine. The higher the Bloom value, the higher the melting and gelling points of a gel, and the shorter its gelling times. The strength of gelatine is typically between 30-300 g Bloom, and is dictated by the chain length and distribution of the polypeptides. Although it is envisaged that any strength of gelatine may be used in the methods of the present invention, one example is gelatine of about 150 Bloom grams. Gelatine is preferably pre-treated by hydrating with water to form a gel prior to incorporation in the cheese/water mixture. In some examples, the ratio of gelatine to water in the hydrated hydrocolloid is 1:99 or 1:100 by weight, or 0.9 to 1.1%, or about 1% gelatine in water. Typically this hydrated hydrocolloid forms a gel on cooling to about 4-10° C., for example after cooling at about 5° C. for 2-12 hours, or overnight.

When used herein, the term “rework” refers to pasteurised cheese product left over or retained from a previous manufacturing batch which is reused (reprocessed or reworked) as a blend ingredient in the manufacture of later batches of pasteurised cheese product. The rework may be obtained from, for example, leftovers removed from heating or processing machinery, damaged packs, and batches which are termed over-creamed or too viscous. Typically, if used, the amount of rework added during the manufacture of a batch of pasteurised cheese product is less than 20% w/w based on the total weight, for example 5-15% w/w or 5-10% w/w, of total cheese/water mass. In some examples, the rework is hot, for example greater than 65° C. In some examples, the cheese pasteurisation manufacture process forms a continuous process and an aliquot of the hot rework is added back into the process.

When used herein, unless otherwise indicated, the term “additional” refers to any quantity of one or more emulsifying agents not naturally found in the particular cheese variety that is the subject of the method.

The inventor has discovered that a hydrated hydrocolloid, for example a polysaccharide hydrocolloid, or a proteinaceous hydrocolloid such as gelatine, may be utilised to aid emulsification or stabilisation of a cheese and water mixture during pasteurisation, thus preventing syneresis. This negates the need for other emulsifying agents or other additives. It also avoids the need for strict adherence to factors such as temperature and heating rate, amount of water and rate of water addition. Thus, in accordance with the methods described herein, cheese can be pasteurised in the absence of additional emulsifying salts or melting salts to provide a stable, substantially homogeneous cheese emulsion. The pasteurised cheese products have excellent shelf life. Furthermore, there is no requirement for additional ingredients such as lactose, starch, butter, skim milk powder, casein, whey, buttermilk, preservatives, stabilizers, or other emulsifying agents. The pasteurised cheese thus retains the characteristic flavour of the parent cheese.

Thus the pasteurised cheese products obtained in accordance with the methods described herein comprise cheese, water and a small amount of hydrocolloid. Typically, in the pasteurised cheese products thus formed, the cheese, water and hydrocolloid together comprise at least 95% w/w of the cheese product. In some examples, the cheese, water and hydrocolloid comprise at least 96% w/w, at least 97% w/w, at least 98% w/w, at least 99% w/w, or at least 99.5% w/w or 99.9% w/w, or substantially 100% of the pasteurised cheese product thus formed.

These pasteurised cheese products have reduced sodium or potassium content when compared with conventional processed cheese products, and therefore may be considered as a healthier alternative. Furthermore, the hydrocolloid does not contribute significantly to the overall flavour of the product and, as additional emulsifying salts are not present, there is an absence of the characteristic salty or bitter taste normally associated with the presence of emulsifying salts. The pasteurised cheese thus is considered to have an improved taste, more characteristic of the original cheese variety, and is lower in sodium than conventional processed cheese made using emulsifying salts.

The general methods described herein are applicable to pasteurisation of many varieties of cheese. It will be appreciated that different varieties of cheese vary in their composition. Characteristics of the cheese variety, such as the moisture content, fat content or the casein content, may have a marked effect on the viscosity and rheology of the cheese during processing and the texture and properties of the final processed cheese product. The skilled artisan will appreciate that adaptation of the processes may be necessary in view of the physical properties of the cheese.

The inclusion of variable quantities of water into the cheese mass in the methods of the present invention alters the composition and physical characteristics of the final product. In the methods of the present invention, cheese is combined and heated with the required amount of water to produce a pasteurised cheese product of the required viscosity and solids content. Addition of water assists in reducing the viscosity of the hot and/or cooled pasteurised cheese product. Preferably, water is added at the commencement of the pasteurisation process. In some embodiments, the water may be comprised only in the hydrated hydrocolloid. However, additional water may also be introduced during the heating process, for example to reduce viscosity of the cheese mass. Similarly, cheese may be added during the heating process to increase viscosity and/or solids content of the pasteurised cheese if required. The amount of water required will depend on several factors, for example the composition and nature of the cheese variety, including its water content. It will be appreciated that certain cheese varieties, such as cottage cheese, include additional water which is not incorporated in the cheese mass in its original form. When used in processes herein, it may thus be unnecessary to include additional water as the emulsification process may utilize the unincorporated water from the originating cheese. The temperature to which the cheese is to be heated and the desired final physical properties of the cooled product will also be factors in determining the amount of water to be added.

In the methods of the present invention, cheese is combined and heated with the required amount of water to produce a pasteurised cheese product of the required viscosity and solids content. Typically, the ratio of water to cheese is between about 10:1 to about 1:10 by weight. In some examples, the ratio of water to cheese is from about 1:1 to about 1:5 by weight, for example approximately 1:2 to 1:4; or approximately 1:2 to 1:3 or 1:1.5 to 1:3 by weight. In some embodiments, the ratio of water to cheese is about 1:2 by weight. In some embodiments, typically the pasteurised cheese has a viscosity of about 5-20 mPa at approximately 80° C. and a solids content of approximately 45% w/w cheese solids.

The hydrated hydrocolloid, cheese and water may be combined in any order, however it is preferable that the cheese is first added to water and then the hydrated hydrocolloid is added to the stirred cheese/water mixture. In some embodiments, the cheese is cold, for example about 5-15° C. Preferably the cheese is finely divided, for example minced or chopped, prior to combining with the water. In some embodiments, the water is suitably cold or ambient, for example 5-15° C. or 15-25° C.

The hydrocolloid may be a polysaccharide hydrocolloid or a proteinaceous hydrocolloid. In some embodiments, the hydrocolloid is a proteinaceous hydrocolloid. In some examples, the proteinaceous hydrocolloid is preferably gelatine. Suitably, the gelatine is combined with water to allow it to hydrate and swell prior to combining with the cheese and water. For example, a hydrocolloid such as gelatine may be hydrated with water at a ratio of about 1 part water to 99 parts water by weight, or 1:100 by weight. Preferably the gelatine is dissolved in water at about 80-100° C., for example about 90-100° C., with stirring. In some embodiments, preferably the hot gelatine/water mixture is then allowed to cool to about 5-10° C. form a gel. Preferably the gelatine/water mixture is stored at about 5° C. Under such conditions, the gelatine/water mixture will typically form a gel which readily combines with the cheese and water mixture.

The amount of hydrocolloid required will depend on several factors, such as the variety of the cheese(s) to be pasteurised and the nature of the hydrocolloid. The skilled person will readily be able to determine the amount and type of hydrocolloid required in accordance with the circumstances. In some embodiments, the ratio of hydrocolloid (non-hydrated weight) to cheese ingredient is from about 1:500 to about 1:1500 by weight, for example about 1:800 to about 1:1200, or approximately 1:1000 by weight. In other words, the amount of hydrocolloid (non-hydrated) used in the cheese emulsification is suitably from about 0.05% to about 0.15% w/w based on the weight of the cheese ingredient, or about 0.08% w/w to about 0.125% w/w. In some embodiments, the ratio of non-hydrated hydrocolloid to cheese ingredient is about 0.09% to about 0.11% w/w, or approximately 0.1% w/w, based on the mass of the initial cheese ingredient.

In some examples, the amount of hydrocolloid in the pasteurised cheese product is approximately 1:1300 to 1:1500 by weight of pasteurised cheese, for example approximately 1:1400 by weight of pasteurised cheese. This represents a cheese product comprising less than 0.1% w/w of hydrocolloid, for example less than 0.08% w/w or less than 0.075% of hydrocolloid, for example 0.067% w/w to 0.077% w/w of hydrocolloid, the remainder substantially consisting of cheese and water. In some examples, the amount of hydrocolloid comprises approximately 0.07% w/w of the pasteurised cheese product, or less.

It will be understood by those skilled in the art that pasteurisation of cheese occurs by raising the temperature of the cheese. In some embodiments, the cheese/water/hydrated hydrocolloid is raised to at least 85° C., and preferably about 95° C. Preferably cold, gelled, hydrocolloid is added to the stirred cheese/water mixture which is suitably at ambient temperature, for example 15-20° C. The mixture is then raised to a temperature of at least 85° C. or 95° C. with stirring. In some preferred embodiments, and is held for at least 10, 15, 20 or 30 seconds, or more, to effect pasteurisation. In some preferred embodiments, the cheese/water/hydrocolloid mass is heated to the desired temperature over a period of from about 30-120 seconds, for example 45-90 seconds or 60-90 seconds. In some embodiments, the heating rate may be changed during the heating process. For example, the rate of heating may be increased after an initial period of slower temperature increase. This may be accompanied by a reduction in the rate of stirring. In some aspects of the methods of the invention, it may be desirable to raise the temperature of the cheese/water/hydrocolloid mass to a higher temperature, for example to reduce the viscosity of the cheese mass for handling purposes, or to prevent it cooling to too low a temperature during handling.

In some aspects, the cheese mixture may be heated to a temperature from about 85° C. to about 120° C. or about 95 to about 120° C., for example 85-90° C., 85-95° C., 85-100° C., 95-100° C., 85-120° C., 80-110° C. or 95-100° C. In some circumstances, it may be desirable to heat the cheese mixture to a temperature of greater than 120° C., such as about 140° C. or about 145° C., so as to effect sterilisation of the cheese mass and ensure destruction of certain pathogens such as Clostridium spp.

In some preferred aspects, the cheese mass is heated to about 85° C., about 90° C. or about 95° C. In some preferred embodiments, the pasteurised cheese emulsion is generally processed to about 95° C. This processing temperature provides pasteurised cheese with improved keeping qualities and extended lifetime. This processing is generally performed using a combination of heating, mechanical stirring and/or cutting. Typically, in some examples the pasteurised cheese mixture is raised to about 95° C., where the molten cheese sol is usually packaged immediately. This is common manufacturing practice in some countries.

It will be appreciated that the viscosity of the melted pasteurised cheese generally decreases with increasing temperature. Casein micelles are believed to control the texture of the cheese mixture by expansion, contraction or dispersion. In some circumstances it is desirable to continue to heat (or cook) the cheese mixture for a period of time at a selected temperature, or temperature range, to effect gelling, or creaming, of the emulsified cheese. The concept of creaming is well known in the art and is commonly used by processed cheese manufacturers. The physical effect of creaming is well recognised. Cooking causes thickening of the pasteurised cheese mixture with increased viscosity. The mixture develops a fine, smooth texture on cooling. This influences the textural properties and firmness of the final cheese product.

The physicochemical mechanisms of creaming are not clearly understood. The viscosity change in melted processed cheese is believed to be due to changes in the structure of the casein. During emulsification, casein particles, or micelles, are believed to be dispersed as smaller, more soluble casein sub-micelles. The sub-micelles have increased surface area and are more readily hydrated. It is believed that the creaming process affects the casein network structure and the size of the milk fat globules. It is postulated that creaming restructures or converts the sub-micelles into an insoluble casein network which increases the viscosity of the hot, pasteurised cheese with resultant effects on the physical properties of the final cheese product (see, for example, Y. Kawasaki, Milchwissenschaft, 2008, 63(2):149-152 and references therein).

Typically, creaming is carried out at temperatures of 80-120° C., for example 80-110° C., 85-110° C., 85-100° C., 85-95° C., 90-110° C., 90-100° C., 95-105° C., 95-100° C. or about 85° C., about 90° C., about 95° C. or about 100° C. In some preferred examples, the creaming process is carried out with stirring or mechanical cutting or agitation. In some examples, the pasteurised cheese mixture is creamed for about 10 minutes; about 5, 4, 3, or 2 minutes; or about 1 minute. In some examples, the pasteurised cheese mixture is creamed for about 30-60 seconds, or about 20-30 seconds.

The phenomenon of over-creaming is well known in the art, and occurs when the pasteurised cheese spontaneously gels and forms an intractable solid, often due to over-heating or over-cooking due to extended creaming times or excess heat. A feature of so-called “over-creamed” processed cheese is its powerful, but uncontrollable, casein emulsifying properties. The over-creamed product can thus act as a powerful emulsifying agent, and cannot be used as rework with any level of success as it can cause sudden gelling or solidification of the pasteurised cheese. This unpredictable nature makes further employment impractical. The solid is deemed unworkable and generally has to be discarded. The pH of the over-creamed pasteurised cheese is not observed to be increased over that of the creamed sol. The major physical change in over-creamed pasteurised cheese is considered to be the uptake of substantially all available moisture.

Without being bound by theory or mode of operation, it is believed that over-heating of the cheese mixture leads to changes in the structure of the casein, in particular the structure of casein micelles. This is believed to lead to excessive uptake of water by the micelles with resultant hydrolysis of the casein.

The present inventor has advantageously discovered that when pasteurised emulsified cheese is prepared using a hydrated hydrocolloid as an emulsifier or stabiliser in accordance with the present invention, the resulting emulsified cheese has a notably fine texture. Moreover, on creaming, the emulsified cheese shows little tendency to over-cream. It is believed that this effect is due, at least in part, to interaction of molecules of hydrated hydrocolloid with the casein micelles resulting in emulsification and stabilisation of the pasteurised cheese and production.

The cheese/water/hydrated hydrocolloid mixture is typically heated to its desired final temperature and then may be allowed to cool to the required temperature for further processing or packaging. The rate of increase in temperature may remain the same throughout the pasteurisation process, or may be varied. In some embodiments, the mixture is heated initially at a lower rate, and then the rate of heating is increased. For example, the cheese/water/hydrocolloid mixture may be initially heated at such a rate so as to increase its temperature from ambient temperature to 50-70° C., for example approximately 50° C., over 40-60 seconds to effect emulsification. The heating rate may then be increased to raise the temperature at a more rapid rate to effect pasteurisation or sterilisation, as required, or to improve handling characteristics by reducing viscosity of the emulsified cheese.

It has also been discovered that polysaccharide or proteinaceous hydrocolloids offer the potential to develop rework emulsifiers which provides access to pasteurised cheese emulsions and, subsequently, pasteurised cheese products that are substantially free of additional components. Thus, a portion of pasteurised cheese produced by pasteurising cheese in the presence of a hydrocolloid and water in accordance with methods described herein, referred to herein as “rework”, may be incorporated into a subsequent cheese pasteurisation batch. This has been discovered to facilitate emulsification of the subsequent batch of cheese/water mixture without the requirement to add additional hydrocolloid. This procedure therefore reduces the amount of hydrocolloid present in the subsequent batch to considerably less than the parent batch. In a similar manner, a portion of a subsequent batch of pasteurised cheese may itself be used as an emulsifying agent in the manufacture of a yet later batch of pasteurised cheese. Although rework reserved from a previous batch of cheese pasteurisation may be used to emulsify subsequent batches, it will be understood that production of pasteurised cheese on a commercial scale is frequently carried out using a continuous process. In such circumstances, it will be appreciated that aliquots of pasteurised, emulsified hot cheese (rework) may be withdrawn from a later stage and re-introduced into an earlier stage of the continuous process to assist emulsification during pasteurisation.

It will be understood that the use of rework cheese as an emulsifier results in a dilution effect with regard to the amount of hydrocolloid present in subsequent batches of cheese pasteurisation. Using this methodology, the amount of hydrocolloid present in a “second generation” pasteurisation batch is reduced to, for example, less that 0.003% by weight of emulsified cheese product. A “third generation” pasteurised cheese may have hydrocolloid present in less than 0.0001% by weight. Typically, rework cheese may comprise 4-5% by weight of the total cheese mass at the commencement of the subsequent pasteurisation batch, for example in a ratio of rework:cheese of 1:20. Thus a pasteurisation method using rework:cheese:water in a ratio of 1:20:8, wherein the rework comprises 0.071% hydrocolloid by weight, will result in a pasteurised cheese with 0.0024% hydrocolloid by weight of the “second generation” pasteurised cheese. Repeating the process using the second generation cheese as an emulsification aid will thus provide a processed cheese containing only 0.000085% w/w hydrocolloid. The use of rework in accordance with the present invention thus has the effect of reducing even further the amount of hydrocolloid present in the pasteurised cheese to negligible amounts, thus potentially providing access to a pasteurised cheese product consisting essentially of cheese and water.

It should be noted that the present methods are not limited in application to only one cheese variety at a time. Under certain circumstances it may be beneficial or convenient to use mixtures of two or more cheese varieties in various proportions. The blending of cheese mixtures or varieties may preferably occur prior to subjecting the mixture to the methods of the present invention, but it may also occur during any one of the methods of the present invention and it may occur after any one of the methods of the present invention.

The present inventor has discovered that Cheddar cheese, regardless of its age, readily undergoes emulsification with water in the presence of hydrocolloid when subjected to methods as described herein. It has also been observed that the rheology of many other varieties of cheese differs from Cheddar and this physical difference is believed to result in some other varieties resisting moisture absorption at lower temperatures. The result can be a deleterious effect on the protein, specifically casein, in the cheese. This may cause the structure of the cheese to collapse even at relatively moderate temperatures, resulting in fat and/or moisture exuding from its bulk rendering the cheese incapable of melting and forming an emulsion with water.

It has been discovered that this problem can be addressed by incorporation of Cheddar during the emulsification of other varieties of cheese. The melting properties of Cheddar make it useful as an additive in the processing of other cheese varieties. The rheology of varieties of cheese often differs from that of Cheddar. It has been discovered that the addition of an aliquot of Cheddar, such as young Cheddar, facilitates the emulsification of other varieties of cheese. The amount of Cheddar is suitably 5-15% w/w, for example 5-12% w/w or 5-10% w/w based on the total amount of cheese. In these proportions it has been observed that the addition of cheddar does not perceptibly affect the flavour of the predominant cheese variety in the final product.

When Cheddar is used to facilitate emulsification of a varietal cheese, such as Emmentaler or Gouda, suitably the Cheddar (for example, 5-15% w/w based on total weight of cheese used) is combined with a portion of the other (varietal) cheese, for example 25% to 50% of the total weight of the varietal cheese to be used. This cheese mixture is then emulsified with the required amount of water and hydrocolloid by raising the temperature to at least 85° C. or greater, for example 85-95° C., under conditions such as those described above, prior to adding the remaining aliquot of the non-Cheddar cheese variety. At this stage, the remaining cheese is added, optionally with an increased stirring rate, over a period of approximately 30-40 seconds.

The inventor has also discovered that Cheddar rework, particularly young Cheddar rework, is useful in assisting emulsification during pasteurisation of varietal cheeses. Accordingly, the present invention also provides for the use of Cheddar rework as an emulsification agent for the pasteurisation of cheese, for example a varietal cheese. Preferably the Cheddar rework has been prepared in accordance with the processed described herein and contains hydrated hydrocolloid as a sole additive. In some examples, rework from a varietal cheese pasteurisation process may be combined or blended with Cheddar before being added to the batch of varietal cheese to be processed. Using this emulsification method, the amount of Cheddar incorporated is small and is generally imperceptible in the pasteurised varietal cheese.

In another aspect, the inventor has discovered that hydrated hydrocolloid combined with young Cheddar provides an effective stabilising or emulsifying agent for pasteurisation of cheese.

Accordingly, the present invention also provides a stabilising or emulsification agent comprising hydrated hydrocolloid and young Cheddar. Preferably the hydrocolloid is gelatine. In some embodiments, the emulsifying or stabilising agent consists of, or consists essentially of, hydrated gelatine, water and young Cheddar. In some embodiments, the amount of hydrocolloid present is less than 0.1% by weight. In some embodiments, the amount of hydrocolloid is from about 0.05 to about 0.075% by weight.

The emulsification/stabilisation agent is prepared by combining hydrated hydrocolloid with young Cheddar and, optionally, water. In another aspect, the present invention provides a process for preparing an emulsifying or stabilising agent comprising the steps of:
hydrating a hydrocolloid with water; and
combining the resulting hydrated hydrocolloid with young Cheddar, and optionally water, to produce a substantially homogeneous mixture.

In some examples, hydrated hydrocolloid, for example hydrated gelatine, is prepared by combining the hydrocolloid with water in a ratio of about 0.5:100 to 2:100 by weight; for example about 1:100 by weight. Preferably, the hydrocolloid/water mixture is stirred to promote mixing and dissolution. Preferably the stirring is sufficiently vigorous to prevent agglomeration of the hydrocolloid. The water is preferably hot, for example 80-100° C. or 90-100° C. After the hydrocolloid has been dissolved in the water, it may be combined directly with the young Cheddar to form the emulsifying/stabilising agent. However, in some embodiments, the hydrated hydrocolloid is allowed to cool to form a gel. Preferably the hydrated hydrocolloid is allowed to stand at about 2-10° C., for example about 5° C., to facilitate gel formation. For example, the hydrated hydrocolloid may be allowed to stand for 4-10 hours, or overnight, at reduced temperatures.

The hydrated hydrocolloid, preferably in the form of a gel, can be combined with young Cheddar and, optionally, water to form an emulsifying agent. In some embodiments, the ratio of hydrated hydrocolloid to young Cheddar is about 0.5:10 to 2:10 by weight, for example about 1:10 by weight. In some embodiments the hydrocolloid is gelled hydrated gelatine.

It will be appreciated that water may be added to the hydrated hydrocolloid/young Cheddar mixture to facilitate mixing and to provide a substantially homogeneous paste-like consistency. The amount of water added to the cheese will depend on the consistency required. For example, the young Cheddar to water ratio may be about 10:2 to 10:6, for example 10:2 to 10:5 or 10:3 to 10:5, or 10:3 or 10:4 by weight. Preferably the young Cheddar is finely divided, for example minced or chopped, prior to combining with the water. In some embodiments, the cheese is cold, for example having a temperature of about 5-10° C. or 5-15° C. The water is preferably at a cold or ambient temperature, for example 5-15° C. or 15-20° C. or 15-25° C. In some embodiments, the cheese/water/hydrocolloid mixture is maintained at about 10-20° C. or 15-20° C. This reduces melting or softening of certain components present in the cheese, such as butter fat. In some embodiments, preferably the cheese/water/hydrocolloid is heated, preferably with stirring or agitation, to about 85° C. or 95° C.

The resulting young Cheddar/water/hydrocolloid mixture is an effective emulsification or stabilisation agent, and finds particular application in pasteurisation of cheese. As such, it may be employed in processes for pasteurisation of cheese such as those described herein where it may be used to replace, either partially or wholly, hydrated hydrocolloid.

It will be appreciated that the young Cheddar/water/hydrocolloid mixture typically contains less than 0.1% by weight hydrocolloid, for example 0.05 to 0.075% by weight hydrocolloid.

It has also been discovered that an emulsification agent with an even lower percentage, or a negligible amount, of hydrocolloid may be prepared. A portion of the hydrated hydrocolloid/young Cheddar emulsion described above (containing less than 0.1% hydrocolloid) may be combined with young Cheddar and water using a similar process to that described above and the mixture reduced to a paste. The ratio of hydrocolloid/young Cheddar paste to young Cheddar is suitably about 0.5:10 to 2:10 by weight, for example about 1:10 by weight. The young Cheddar to water ratio may be about 10:2 to 10:6, for example 10:3 to 10:5, or 10:4 by weight. The resulting emulsifying agent contains a negligible amount of hydrocolloid (approximately 0.004% by weight). This process may be repeated to further dilute and reduce the amount of hydrocolloid in the emulsification agent.

Accordingly, the present invention further provides a process for preparing an emulsifying agent comprising the steps of:

a) hydrating a hydrocolloid with water;

b) combining the resulting hydrated hydrocolloid with young Cheddar, and optionally water, and raising the temperature to at least 85° C. to produce a substantially homogeneous emulsifying agent wherein the amount of hydrocolloid present is less than 5% w/w, preferably less than 1% w/w or 0.5% w/w;

c) reserving a portion of the mixture of step (b);

d) combining the portion of step (c) with young Cheddar, and optionally water, and raising the temperature to at least 85° C. to produce a substantially homogeneous emulsification agent wherein the amount of hydrocolloid present is less than that present in step (b); and optionally;

e) reserving a portion of the mixture of step (d); and

f) combining the portion of step (e) with young Cheddar, and optionally water, and raising the temperature to at least 85° C. to produce a substantially homogeneous emulsifying agent wherein the amount of hydrocolloid present is less than that in step (d).

The hydrocolloid/young Cheddar emulsifying agents described above may advantageously be used in the pasteurisation of a cheese, such as, but not limited to, mature Cheddar. The emulsifying agent may be used in ratios of emulsifier to cheese of up to 10:100 by weight, for example 2:100 to 10:100, 5:100 to 10:100, or 8:100 to 10:100. It will be appreciated that it is conventional in the art to incorporate water into the cheese during pasteurisation. Examples of cheese to water ratios include, but are not limited to, about 10:2 to 10:6, for example 10:3 to 10:5, or 10:4 by weight. Preferably the emulsifying agent is heated to about 80-100° C. prior to incorporation into the cheese/water mixture, for example 90-100° C., or about 95° C. Cheese pasteurised under these conditions contains a negligible amount of hydrocolloid.

The inventor has observed that cheese pasteurised and creamed using a hydrated hydrocolloid/young Cheddar emulsifier produces a very fine emulsion which provides a creamy texture on the palate.

It has been observed that cheese manufactured using milk protein concentrate or milk protein isolate (MPC) may exhibit multiple layers or phases when emulsified with gelled gelatin. The present inventor has discovered that use of hydrated hydrocolloid/young Cheddar emulsifying agent, or rework derived from such an emulsifier, appears to overcome this deficiency. Without being bound by theory or mode of operation, it is believed that young Cheddar has a high level of intact casein due to lack of hydrolysis of the protein. This is believed to stabilise the pasteurised cheese.

The ability to add cheese to a hot emulsified pasteurised cheese prepared according to methods described herein without any adverse effect on the physical properties of the cheese mass has the advantageous effect of raising the solids content of the pasteurised cheese mass to, for example, greater than 50% w/w cheese solids. Thus, in another aspect, this provides a pasteurised cheese product of greater viscosity and physical properties which, on cooling to room temperature or below, provides a cheese product that is suitable for slicing or otherwise shaping by cutting, or for forming blocks of pasteurised cheese.

It will be appreciated that the amount of cheese solids present in the final product may be increased by removal of water from the cheese mass. Accordingly, in another embodiment, the methods of the present invention may be expanded to include the step of subjecting the liquid emulsified cheese mass to conditions of such temperature, pressure and humidity as to effect evaporation of at least a portion of the water in that liquid mass. The cheese mass may also be subjected to separately, sequentially or simultaneously cooling it to near room temperature and evaporating a portion of the water to afford a solid cheese product. Additionally, finely dividing the mass with subsequent evaporation of a substantial proportion of water can afford a solid cheese product in the form of a cheese powder.

Preferably the process of raising the temperature of the cheese, hydrated hydrocolloid and water mixture to effect emulsification is carried out with mixing. The mixing may be enhanced by fine division of the cheese using, for example, mincing, milling, macerating or grinding. Suitable vessels and equipment for pasteurisation of cheese are well know in the field of food and cheese processing. In one embodiment, the cheese, water and hydrocolloid are mixed together in a vessel fitted with sharpened rotatable blades. Preferably the blades are adapted to rotate at variable speed. Alternatively, the cheese, hydrated hydrocolloid and water are brought into contact in a vessel with simultaneous thorough mixing using an impeller. Preferably the impeller can rotate at a variable speed. Preferably the cheese, hydrated hydrocolloid and water are mixed under conditions such that the water is incorporated completely into the cheese mass.

The temperature of the cheese/water/hydrated hydrocolloid mixture may be raised using any suitable heating means known in the art. For example, the vessel containing the cheese mixture may be fitted with a heating jacket containing circulating heated fluid, for example water optionally under pressure, to raise the temperature of the mixture.

If desired, the cheese mixture may be heated under pressure, or under vacuum using suitable processing equipment known in the art. However, in exemplary embodiments the cheese/water/hydrated hydrocolloid mixture is heated at approximately atmospheric pressure.

The methods described herein are predicated in part on the absence or reliance on the use of additional emulsifying agents, for example emulsifying or melting salts such citrate, tartrate, phosphate or phosphonate salts of sodium or potassium. The skilled person will understand that certain varieties of cheese may naturally comprise small quantities of salts, such as sodium citrate. Accordingly, the pasteurised cheese prepared according to the methods described herein is considered to be free of additional emulsifying salts.

It will be appreciated that the pasteurised cheese prepared in accordance with the present invention will have a high cheese content and, being substantially free of additives such as emulsifying salts or other ingredients, the cheese product will retain characteristics of the flavour of the original cheese. Accordingly, Cheddar cheese pasteurised in accordance with the present methods will retain much of the varietal flavour of the original cheese. Similarly, Emmentaler pasteurised in the presence of a small amount of Cheddar will substantially retain the characteristic flavours of Emmentaler. It is envisaged that the pasteurised cheeses will be readily consumed and enjoyed without the need for any additional ingredients or flavourings, and this is a preferred embodiment. However, the present pasteurisation methods lend themselves to incorporation of flavouring agents, particularly when the cheese is in a less viscous form, for example when it is at an elevated temperature. Examples of flavouring agents include herbs, spices, fruits, berries, nuts and vegetables. Other examples of flavouring agents include meat products.

Following pasteurisation of the cheese, the resulting cheese mass may be subjected to one or more additional process steps. For example, the hot cheese mass may be heated to a higher temperature, such as 80-90° C., to allow the cheese to be poured to form a sheet of pasteurised cheese which can then be cut, for example into squares, and wrapped to form individually wrapped cheese slices. In some embodiments, the temperature of the cheese mass may be raised to greater than 100° C. or 120° C. to effect sterilization of the cheese mass. In some embodiments, the methods of the present invention may include a step of cooling the hot liquid cheese mass to approximately room temperature, with or without mixing. The cooled product may take the form of a spreadable gel, or may be in the form of a more viscous paste, depending on the amount of water present in the mixture and the nature and characteristics of the cheese used. A spreadable gel is a semi-liquid product which does not fracture on division but rather may be spread on a surface, such as a paste.

In another embodiment, the methods of the present invention may be expanded to include a step of subjecting the pasteurised cheese mass to conditions of such temperature, pressure and humidity as to effect evaporation of a substantial proportion of the water in that liquid mass. In some embodiments, the pasteurised cheese mass may be subjected to spray drying, for example at about 45% solids.

Without wishing to be bound by theory it is believed that modifying such conditions provides control over the amount of moisture absorbed by the protein within the cheese mass. The product of such a method may take the form of a block or slice of substantially solid cheese. Further reduction of moisture may be used to form a biscuit. In another embodiment, the method of the present invention may be elaborated by incorporating the steps of finely dividing the hot liquid cheese mass before subjecting it to conditions under which evaporation of some of its moisture may occur. As used herein, the term “finely dividing” refers to methods whereby the mass is divided into particles such as droplets. In particular, the cheese mass may be passed through a nozzle, creating such shear as to separate it into discrete droplets of pre-determined and desired size. The finely divided material may be subjected to conditions of such temperature, pressure and humidity as to effect evaporation of a substantial proportion of the water within that finely divided material. This evaporation may occur while the material is in a suspended state and/or following contact with a surface. In any event, the step of evaporation may, or may not, follow a cooling step, whereby the hot liquid mass is cooled to a pre-determined temperature.

In some embodiments, where the method includes adding additional cheese to the emulsified pasteurised cheese mixture during or after heating to increase the amount of solid present and hence the viscosity, the cooled product will be more solid in form and texture. In these embodiments it will be appreciated that the product may take the form of a block or a slice of substantially solid cheese, or a biscuit or cheese powder as described above.

In some embodiments, the methods of the invention may be elaborated to provide pasteurised cheese slices, preferably pasteurised cheese slices that are individually wrapped. Accordingly, the hot pasteurised cheese mass may be manipulated to form a sheet of pasteurised cheese which may then be cut to form uniformly sized squares which may then be individually wrapped if so desired. Individual wrapping of cheese slices comprising pasteurised cheese according to the methods described herein provide a product that is nutritious with a high degree of purity and authentic cheese flavour. In addition, it is transportable and can if desired be conveniently eaten without the need to touch the cheese by removal of part of the wrapping. Methods of providing cheese in the form of a sheet are well known in the art and include, for example, pouring the hot liquid cheese mass to form a layer, or extruding the cheese mass through a suitably shaped die or slot to form a sheet of pasteurised cheese. In some embodiments, the cheese layer may be formed on a conveyor belt as part of a continuous process.

In a preferred embodiment, the hot liquid pasteurised cheese may be extruded or poured into a preformed continuous tube of film. This filled tube is then flattened to form a ribbon and formed into slices, usually substantially square, by crimping the ribbon at intervals. The crimped ribbon is then heat sealed and cooled prior to cutting the ribbon at the crimped portions. The required number of individually wrapped slices may then be stacked and packaged. Suitable extruder equipment is known in the art, and is commercially available from, for example, Hart Design and Manufacturing.

In some examples, it is preferred that the pasteurised cheese is raised to a temperature of 85-90° C., or more, prior to extrusion thus providing liquid cheese that is of sufficiently low viscosity for ease of filling the tube. Furthermore, this elevated temperature ensures that the cheese temperature remains sufficiently high during the filling and sealing process to allow a vacuum to form within the sealed cheese slice on cooling. This increases the shelf life of the cheese and reduces risk of infection and spoilage.

The cooled cheese products are typically stable at room temperature (or preferably at cooler temperatures) for greater than one month, and more preferably for greater than twelve months. Preferably the products of the methods described herein are stable for a period of greater than 12 months at a temperature of less than 10° C., preferably less than 5° C. The cooled products preferably resist spoilage and are not susceptible to substantial desiccation. The products of the methods described herein, following atmospheric exposure, have been observed to develop a surface layer which is slightly desiccated in character due to evaporation of surface moisture. Without wishing to be bound by theory, this surface layer is believed to discourage spoilage due to growth of microorganisms. When covered, desiccation is slow and the cheese product remains viable as a foodstuff for a substantial period of time.

The methods as described herein are applicable to a wide range of process scales using suitable apparatus well known in the art. In particular, the method may be applied through the use of, for example, a cheese “kettle” comprising heating means such as a jacket which is capable of circulating a heating/cooling liquid such as water. The vessel is preferably equipped with means for stirring the contents. Furthermore, application of a continuous manufacturing process to the methods of the present invention is anticipated. A vessel, such as a pipe, through which the flow of a material may be regulated, represents a particularly suitable apparatus through which the methods of the present invention may be performed. Vessels consisting of one or more tubes can be used to circulate the cheese mass using a pump with high velocity and with induced turbulent flow to distribute the supplied heat whilst mixing and homogenizing the mass. Such a vessel may also employ an arrangement of rotating cutters through which the cheese mass is directed.

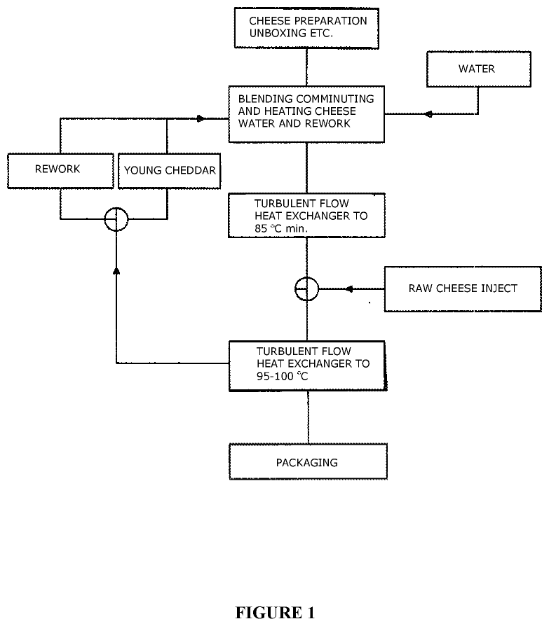

An example of a generic continuous manufacturing process according to an aspect of the present invention is illustrated in the schematic diagram of FIG. 1. It will be appreciated that the properties of a cheese will vary in accordance with the cheese variety. For example, Cheddar may sustain a continuous melting process from 50-100° C. without any adverse effects. Some cheese varieties, such as Emmentaler, have a dry, dense texture which benefits from the presence of an increased level of water at the beginning of the process. This may be addressed by retaining a portion of the raw cheese and adding the reserved portion at the end of the process. Preferably, the retained portion is injected into the hot cheese stream during the process. The hot viscosity of the cheese mass in a continuous process is typically below 10 mPa.

Viscosity measurement is a useful indication of the physical properties of the products of the methods of the present invention. It will be understood that the viscosity will depend on the variety of cheese used, the amount of water present and the temperature of the emulsified cheese. The viscosity of the cheese in the final cooled product can be modified by varying the ratio of water and cheese in the hot product.

For the present purposes, viscosities were obtained at atmospheric pressure at the indicated temperature using an AND sine wave “vibro” SV-10 viscometer (A&D Mercur Pty Ltd) having standard RS-232C connectivity and Win viscometer software. “Hot viscosity” is generally determined when the cheese mass is between 70° C. and 90° C. “Warm viscosity” is determined when the temperature of the cheese mass is between about 35° C. and −45° C. In some embodiments, a cheese emulsion of the invention has a hot viscosity of 5 to 20 mPa at 80° C. with a solids content of 44-45% cheese solids.

The viscosity of a product of the invention may be varied by altering the amount of water present before and during the heating of the cheese. It will be appreciated that control of the viscosity of the pasteurised cheese product will assist in production of a cheese product with the required physical properties. For example, a pasteurised cheese product in the form of a gel or paste will require a lower viscosity, and hence a higher proportion of water, than a shaped cheese product such as cheese slices. Similarly, a dried cheese product, such as cheese powder, will be more economic to produce if the cheese is pasteurised at high viscosity/low water content to reduce energy in removing water from the liquid pasteurised cheese mass.

In order that the invention may be readily understood and put into practical effect, particular preferred embodiments will now be described by way of the following non-limiting examples.

### EXAMPLES

### Materials

Cheddar Cheese used herein was traditionally manufactured young (14 week old) Cheddar sourced from Maffra Cheese Company, Maffra, Victoria, Australia. Cheeses such as Emmentaler and Gouda are readily available from commercial sources. Preferably the cheeses do not contain milk protein concentrate.

Hydrocolloids of suitable type and purity for use in food manufacture are readily available from commercial suppliers. The hydrocolloids were hydrated with water prior to use. Generally gelatine was prepared by combining food grade gelatine powder (1 g, type-B bovine, strength 150 Bloom grams) with water (99 g) and allowing the gelatine to swell and thus form a paste.

Cheese pasteurisation was carried out at atmospheric pressure using a covered and jacketed vessel equipped with a cutter (sharpened knives) and bowl scraper.

### Example 1: Pasteurisation of Cheddar Using Gelatine

Hydrated gelatine was prepared by combining gelatine powder (1 g, strength 150 Bloom grams) with water (99 g) and allowing to swell to form a gel. The gel (100 g) was combined with Cheddar (1 kg) and water (300 g). The mixture was heated by indirect water vapour at atmospheric pressure and raised to 50° C. over 50-60 seconds under vigorous stirring in a jacketed vessel using rotating sharpened knives. The rate of mechanical stirring was reduced, and the vapour temperature was increased rapidly to 95-100° C. allowing the temperature of the cheese mixture to rise to 95° C. or higher.

The emulsion had a hot viscosity of 5 to 20 mPa when allowed to cool to 80° C. The product was obtained as a low viscosity, stable emulsion with a solids content of 44-45% cheese solids, and a gelatine content of approximately 0.071% w/w based on the initial total weight of ingredients.

### Example 2: Pasteurisation of Cheddar Using Gelatine Rework

Cheddar (1 kg) was combined with water (400 g) and product of Example 1 (“rework”, 50 g). The mixture was heated by indirect water vapour at atmospheric pressure with mechanical stirring (rotating sharpened blades) using the procedure described above for Example 1.

The pasteurised cheese produced in Example 2 was similar to that produced in Example 1, however the pasteurised cheese emulsion had a gelatine content of 0.0024% w/w based on the initial amounts of ingredients.

### Example 3: Pasteurisation of Cheddar Using Second Generation Gelatine Rework

Cheddar (1 kg) was combined with water (400 g) and product of Example 2 (“rework”, 50 g). The mixture was heated by indirect vapour at atmospheric pressure with mechanical stirring using the procedure described above for Example 1. The pasteurised cheese produced in Example 3 was similar to that produced from Examples 1 and 2, however the pasteurised cheese emulsion of Example 3 had a gelatine content of only 0.000085% w/w based on the initial amounts of ingredients.

### Example 4: Pasteurisation of Swiss Cheese

Swiss cheese (Emmentaler, 200 g), Cheddar (50 g), water (400 g) and hydrated gelatine (30 g) were combined with mechanical stirring using sharpened knives in a jacketed vessel. The ingredients were processed by raising the temperature to approximately 80-90° C. with stirring. The speed of the stirring was increased and a further portion of Emmentaler (400 g) was added over a period of about 30-40 seconds.

### Example 5: Pasteurisation of Swiss Cheese Using Rework

Swiss cheese (Emmentaler, 250 g) and traditionally manufactured Cheddar (50 g) were combined with Cheddar rework (e.g. from Example 1, 50 g) and water (400 g). The mixture was heated by indirect vapour at atmospheric pressure using a jacketed vessel and the temperature was raised to 75° C. over 40 seconds under vigorous stirring using sharpened knives. A further portion of Swiss cheese (250 g) was added and this almost immediately produced a uniform, stable emulsion.

### Example 6: Pasteurisation of Gouda

The procedure of Example 4 was repeated using Gouda instead of Swiss cheese and was found to provide a uniform, stable emulsion.

### Example 7: Preparation of Gelatine/Young Cheddar Emulsifying Agent

Gelatine (1 g) was diluted in hot water (100 g; approximately 90-100° C.) with vigorous stirring. The resulting solution was allowed to gel by standing at about 5° C. overnight. The cold gel was combined with cold young Cheddar cheese (about 5-10° C., minced, 1000 g) and water (ambient temperature, 400 g) and the mixture was reduced to a paste using a blender. The paste was retained at below 20° C. to reduce likelihood of softening of butter fat present in the Cheddar. This emulsifier contains approximately 0.07% gelatine by weight (Example 7A). This was observed to act as an effective and efficient emulsification/stabilisation agent for the pasteurisation of cheese.

To prepare an emulsification agent with an even lower percentage of gelatine, a portion of the above paste (100 g, 10-20° C.) was combined with young Cheddar (about 5-10° C., minced, 1000 g) and water (ambient temperature, 400 g) and the mixture was reduced to a paste using a blender. This emulsifying agent (Example 7B), containing a negligible amount of gelatine (approximately 0.004% by weight), was observed to act as an effective emulsifier for pasteurisation of cheese.

### Example 8: Pasteurisation of Cheddar Using Gelatine/Young Cheddar

The resulting paste obtained in Example 7 (A or B, 100 g) was heated by jacket hot water to about 95° C. and was then used to emulsify Cheddar (1000 g) and water (400 g) using a procedure analogous to that of Example 4.

The inventor has observed that a notable feature of the pasteurised cheese emulsified in this fashion is comprised of a very fine emulsion. On tasting, the pasteurised cheese prepared using this technique has been found to provide a melting consistency on the palate, similar to a creamy consistency.

### Example 9: Preparation and Use of Gelatine/Young Cheddar Emulsifying Agent

Young cheddar (about 12 to 14 weeks) was blended with water in a ratio of 10:3 by weight. To this was added an emulsifier comprising hydrated gelatine (gel) prepared by dissolving gelatine in water at a ratio of about 1:100. The amount of gel used was 100 g to 1000 g cheese, i.e. a ratio of 100:1000. The ingredients were thoroughly combined in a food blender, such as a Stephan cheese processing kettle, and raised in temperature by jacket water-vapour, evaporated at between 100° C. to about 105° C. to avoid burn-on of casein, to a temperature preferably above 85° C. This “rework” product (Product 9a, 1400 g) contained 1000 g cheese, 300 g water and 100 g hydrated gelatine, which equates to a gelatine percentage of 0.0714% ( 1/1400).

The above process was repeated by adding “rework” Product 9a (100 g) instead of the 100 g of hydrated gelatine to 1000 g cheese and 350 g water. The cheese to water ratio was 10:3.5:or 1000 g cheese, 350 g water plus 100 g rework (approximately 45-50% solids) (Product 9b). The gelatine content was thus reduced to 0.005% (0.0714/1450).

Product 9b (100 g) was then used to emulsify a further batch of cheese (1000 g) and water (350 g) as described above to provide pasteurised cheese with a gelatine content of about 0.005/1450 or 0.00034%, or 99.999% pure. This pasteurised cheese batch may be used as an emulsifier for pasteurisation of a batch of in excess of 203 Kg.

It will be appreciated that the cheese to be processed referred to in this example may be Cheddar (mature or young), or another variety of cheese such as Gouda, Edam, Emmentaler or Gruyere. The use of young Cheddar is economical as it is cheaper than mature cheese, and thus reduces cost of production of pasteurised cheese by replacing a proportion of the mature cheese. This can be achieved without adversely affecting the flavour of the resulting pasteurised product which retains the flavour of the mature cheese.

### Example 10: Preparation and Use of Hydrocolloid/Young Cheddar Emulsifying Agent

Young cheddar (1 Kg, about 3 to 4 months maturation) was combined with water (100 mL) containing dissolved hydrocolloid (1 g), followed by combining with water (400 mL). The product was heated to 95° C. in a laboratory configured, jacketed kettle. An aliquot (100 g) of the resulting product (rework) was combined with a further mixture of cheese (1 Kg) and water (400 g) and the temperature of the mixture was raised to about 95° C.

The product thus produced will emulsify 14 Kg of cheese/water mixture (10 Kg cheese, 4 Kg water) and, when combined with a further 140 Kg of cheese/water mixture, the resulting emulsified cheese mass will have substantially no hydrocolloid content.

FIG. 1 shows a schematic representation of continuous process. Thus, cheese is unpacked, comminuted and blended with water and emulsifier. The product is then pumped to a heat exchanger to be heated to the required pasteurisation temperature (for example 85-95° C.). Provision is made to feed raw cheese of the same of different variety into the flowing mass at about 80° C. in the presence of apparatus to combine the ingredients. An aliquot of the hot product (rework) is diverted, preferably via a pre-blender to be combined with young Cheddar as rework, or directly to be blended.

### OTHER EXAMPLES

Similar procedures to those described above were performed using other hydrated hydrocolloids such as guar gum or xanthan gum instead of gelatine. These hydrated colloids were found to perform in a similar manner to hydrated gelatine when used in the pasteurisation of cheese.

The inventor has noted that when hydrated xanthan gum was used as an emulsification agent during the pasteurisation of cheese, the texture of the resulting cheese had a “longer” texture, providing a finished cheese product with increased flexibility compared to comparable cheese product prepared using hydrated gelatin emulsification agent.

The disclosure of every patent, patent application, and publication cited herein is hereby incorporated herein by reference in its entirety.

The citation of any reference herein should not be construed as an admission that such reference is available as “Prior Art” to the instant application.

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appended claims.

1. A method for pasteurising cheese comprising raising the temperature of the cheese to at least 85° C. in the presence of water and a sufficient amount of a hydrated hydrocolloid such that the water is incorporated into the cheese without syneresis to provide pasteurised cheese in a substantially homogeneous form; the cheese, water and hydrocolloid together forming at least 95% w/w of the pasteurised cheese thus formed, wherein the cheese is pasteurised in the absence of additional emulsifying salts.

2. The method according to claim 1, wherein the cheese, water and hydrocolloid together form at least 99% w/w of the pasteurised cheese thus formed.

3. (canceled)

4. The method according to claim 1, wherein the cheese comprises one or more cheese varieties selected from the group consisting of rennet varieties.

5. The method according to claim 1, wherein the cheese comprises one or more varieties selected from the group consisting of Emmentaler, Colby, Gouda, cream, cottage, and Cheddar including young Cheddar and mature Cheddar.

6. The method according to claim 1, wherein the cheese is young Cheddar.

7. The method according to claim 1, wherein the ratio of water to cheese of from about 10:1 to about 1:10 by weight.

8. The method according to claim 1, wherein the ratio of water to cheese is about 1:1 to about 1:5 by weight.

9. The method according to claim 1, wherein the ratio of water to cheese is about 1:2 to about 1:4 by weight.

10. The method according to claim 1, wherein the hydrocolloid is a proteinaceous hydrocolloid.

11. The method according to claim 1, wherein the hydrocolloid is hydrated gelatine.

12. The method according to claim 11, wherein the gelatine is hydrated to form a gel prior to incorporation with the cheese and water.

13. The method according to claim 1, wherein the ratio of hydrocolloid to cheese is about 1:800 to about 1:1200 by weight.

14. The method according to claim 1, wherein the ratio of hydrocolloid to cheese is about 1:1000.

15. The method according to claim 1, wherein the amount of hydrocolloid present in the pasteurised cheese is less than 0.1% by weight of pasteurised cheese.

16. The method according to claim 1, wherein the amount of hydrocolloid present in the pasteurised cheese is less than 0.08% by weight of the pasteurised cheese.

17. The method according to claim 1, wherein the pasteurised cheese viscosity is 5-20 mPa at about 80° C.

18. The method according to claim 1, wherein the pasteurised cheese comprises 40-50% cheese solids.

19. The method according to claim 1, comprising a step of adding an additional aliquot of cheese to the pasteurised cheese to increase the amount of cheese solids.

20. A method for pasteurising cheese to form a spreadable gel, said method comprising the steps of:
a) raising the temperature of the cheese to at least 85° C. in the presence of water and a sufficient amount of a hydrated hydrocolloid such that the water is incorporated into the cheese without syneresis to provide pasteurised cheese in a substantially homogeneous form; and
b) cooling the pasteurised cheese to less than 30° C., wherein the cheese, water and hydrocolloid form at least 95% w/w of the spreadable gel thus formed.

21. A method for pasteurising cheese to form a substantially solid cheese product, said method comprising the steps of:
a) raising the temperature of the cheese to at least 85° C. in the presence of water and a sufficient amount of a hydrated hydrocolloid such that the water is incorporated into the cheese without syneresis to provide pasteurised cheese in a substantially homogeneous form; and
b) adding a further aliquot of cheese, which may be the same or different to the cheese in step a), to the cheese mass thus formed; and/or
c) subjecting the cheese mass to conditions of such temperature, humidity and pressure so as to remove a portion of the water from the cheese; and
d) cooling the pasteurised cheese to less than 30° C. wherein the cheese, water and hydrocolloid form at least 95% w/w of the substantially solid cheese product thus formed

22. A method for preparing pasteurised cheese comprising the steps of:
a) raising the temperature of a cheese to at least 85° C. in the presence of water such that the water is incorporated into the cheese, wherein the incorporation of water is performed in the presence of a hydrated hydrocolloid in sufficient amount to prevent syneresis; and
b) reserving a portion of the pasteurised cheese of step a); and
c) raising the temperature of a cheese, which may be the same or different to the cheese in step a), to at least 85° C. in the presence of water such that the water is incorporated into the cheese, wherein the incorporation of water is performed in the presence of the pasteurised cheese portion of step b) in sufficient amount to prevent syneresis.

23. A method according to claim 22, wherein the pasteurised cheese portion of step b) comprises 4-5% by weight of the total cheese mass of step c).

24. A method according to claim 22, wherein the pasteurised cheese includes hydrocolloid in an amount of less than 0.003% by weight of cheese product.

25. A method according to claim 22, further comprising a step d) wherein a portion of the pasteurised cheese of step c) is retained and is used in a further cheese pasteurisation step e).

26. A method according to claim 25, wherein the pasteurised cheese product produced in step e) includes hydrocolloid in less than 0.0001% by weight of pasteurised cheese product.

27. A method for preparing an emulsifying or stabilising agent for pasteurisation of cheese comprising the steps of:
hydrating a hydrocolloid with water; and
combining the resulting hydrated hydrocolloid with young Cheddar and, optionally, water to produce a substantially homogeneous mixture.

28. A process for preparing an emulsifying agent comprising the steps of:
a) hydrating a hydrocolloid with water;
b) combining the resulting hydrated hydrocolloid with young Cheddar, and optionally water, and raising the temperature to at least 85° C. to produce a substantially homogeneous emulsifying agent wherein the amount of hydrocolloid present is less than 5% w/w, preferably less than 1% w/w or 0.5 w/w;
c) reserving a portion of the mixture of step (b);
d) combining the portion of step (c) with young Cheddar, and optionally water, and raising the temperature to at least 85° C. to produce a substantially homogeneous emulsifying agent wherein the amount of hydrocolloid present is less than that in step (b); and optionally;
e) reserving a portion of the mixture of step (d); and
f) combining the portion of step (e) with young Cheddar, and optionally water, and raising the temperature to at least 85° C. to produce a substantially homogeneous emulsifying agent wherein the amount of hydrocolloid present is less than that in step (d).
